(19) United States
(12) Patent Application Publication
(10) Pub. No.: US 2024/0097167 A1
(43) Pub. Date: Mar. 21, 2024

(54) COMPRESSOR ARRANGEMENT FOR A FUEL CELL SYSTEM

(71) Applicant: ZF Friedrichshafen AG, Friedrichshafen (DE)

(72) Inventor: Raphael Zwick, Wangen (DE)

(73) Assignee: ZF Friedrichshafen AG, Friedrichshafen (DE)

(21) Appl. No.: 18/557,641

(22) PCT Filed: May 3, 2022
(86) PCT No.: PCT/EP2022/061766

§ 371 Date: Oct. 27, 2023

(30) Foreign Application Priority Data
May 5, 2021 (DE) 10 2021 204 515.4

(51) Int. Cl. H01M 8/04746; H01M 8/04089; H01M 8/0438

(52) U.S. Cl. CPC H01M 8/04753; H01M 8/04089; H01M 8/04395

(57) ABSTRACT

A compressor arrangement for a fuel cell system, such as a vehicle fuel cell system, has at least one compressor stage configured to draw in a mass-flow of air, compress it, and deliver the compressed mass-flow. A compressor control system is configured to control the compressor stage, to be connected for signal exchange with a fuel cell control system, and to receive from the fuel cell control system control commands in the form of one or more reference variable signals. The reference variable signal contains a mass-flow target value signal, the compressor arrangement comprises a sensor arrangement with a mass-flow sensor for detecting the air mass-flow as a control variable. The compressor control system is connected for signal exchange with the sensor arrangement and is configured to generate a control signal for the compressor stage as a function of the control variable and the reference variable.

### RELATED APPLICATIONS

This application claims the benefit under 35 U.S.C. § 371 as a U.S. National Phase Application of Application no. PCT/EP2022/061766, filed on 3 May 2022, which claims benefit of German Patent Application no. 10 2021 204 515.4 filed 5 May 2021, the contents of which are hereby incorporated herein by reference in their entireties.

### FIELD OF THE DISCLOSURE

The present invention relates to a compressor arrangement for a fuel cell system, in particular for a fuel cell system in a vehicle, with at least one compressor stage which is designed to draw in a mass-flow of air, compress it, and deliver the compressed air mass-flow as a reactant supply, and to a compressor control system which is designed to control the compressor stage and which is designed to be connected for signal exchange with a fuel cell control system and to receive control commands from the fuel cell control system.

### BACKGROUND

Compressor arrangements of the type indicated above are generally known. The known compressor arrangements comprise single-stage or multi-stage compressors which serve to supply a fuel cell system on its cathode side with a material mix containing oxygen, at least in the form of compressed air. Hydrogen is supplied to the fuel cell system on its anode side. So that a controlled reaction will take place, it is necessary to monitor and control the reaction conditions and the reactant quantities supplied, i.e., the material mix of oxygen supplied and the hydrogen supplied. That task is usually carried out by the fuel cell control system.

In the known systems a communication between the fuel cell control system and the compressor arrangement functionally connected to the fuel cell control system takes place in such manner that the fuel cell control system receives measurement signals from a sensor arranged decentrally in the system, which signals are representative of the quantities of air and oxygen supplied to the fuel cell system. If the fuel cell control system detects values from the measured sensor that indicate the quantities of air or oxygen supplied to the fuel cell are too small, it emits a control command to the compressor arrangement to adapt the compressor performance, for example, by increasing the rotation speed of the compressor stages. If the fuel cell control system carries out a regulating process, the signal is fed back to the fuel cell control system. As in the case of internal combustion engines, the sensors connected to the fuel cell control system can be arranged, for example, in the inlet manifold of the fuel cell control system for the oxygen supply.

Although the above-described systems by and large function satisfactorily, there is nevertheless a need for further improvements. Above all, it is sought to further improve the suitability of the compressor arrangement for system integration.

### SUMMARY

The purpose of the present invention is therefore to indicate a compressor arrangement that enables better system integration.

In a compressor arrangement of the type indicated above, the invention proposes that the control commands should contain a target value signal representative of a required reactant supply as a reference variable, the compressor arrangement should comprise a sensor arrangement for detecting a control variable, and the fuel cell control system should be connected for signal exchange with the sensor arrangement and should be designed to generate a control signal for the compressor stage as a function of the control variable and the reference variable.

The invention is based on the recognition that instead of a control variable that is directly relevant for the compressor's performance, but is abstract, such as the required rotation speed, by virtue of the invention a control concept is introduced with which the fuel cell control system only has to request from the compressor arrangement a material mix quantity of air to be supplied that is required for carrying out a controlled reaction in the fuel cell system, and is relieved of the task of regulating. Since the compressor arrangement is connected for signal exchange with the sensor arrangement and the sensor arrangement is a system constituent of the compressor arrangement itself, it is possible for the compressor control system to receive the measured values from the sensor arrangement directly. Since the task has been transferred from the fuel cell control system to the compressor control system, the compressor arrangement is additionally enabled to detect the control deviation between the reference variable and the control variable and to control the relevant components of the compressor arrangement, such as the compressor stage(s), in such manner that that the control deviation is eliminated. This has many advantages: on the one hand the system inertia in the regulation of the reactant quantities delivered by the compressor arrangement is reduced, because instead of the fuel cell control system, now the compressor control system can carry out the regulation of the compressor's performance directly and by itself. On the other hand, it is possible for the communication between the fuel cell control system and the compressor control system to be pared down for the same regulation objective. The feedback of the signal return can now be taken over by the compressor control system and the communication between the sensor arrangement and the compressor control system inside the compressor arrangement can take place by way of dedicated signal transmission paths without occupying the system-wide data transmission paths by way of which the compressor arrangement and the fuel cell control system would usually communicate.

Inasmuch as, above and in what follows, the terms ‘air’, ‘oxygen’ and ‘oxygen-containing material mix’ are used to describe the material mix delivered by the compressor arrangement, in connection with the invention it should be understood that those terms are interchangeable since the compressor arrangement is designed and suitable for drawing in, compressing and delivering in compressed form as a reactant supply any materials or material mix. In particular the term ‘air’ should be understood as a collective term for oxygen and oxygen-containing material mixes.

In a further development of the invention the target value signal that represents the reactant supply required is a mass-flow target signal, and the sensor arrangement comprises a mass-flow sensor for detecting the mass-flow of air as a control variable. The use of the air mass-flow as a reference and control variable is advantageous for a reliable determination of the reactant quantities supplied.

In a preferred embodiment the compressor arrangement comprises a compressor housing in which the at least one compressor stage is accommodated, and the sensor arrangement is structurally integrated in the compressor housing. In the context of the invention, structural integration is understood to mean that the sensor arrangement is arranged partially or completely within the compressor housing. Structural integration is also understood to mean that part of the surface of the sensor arrangement at the same time forms part of the surface of the compressor housing. However, the components that are relevant for measurements and the data interfaces of the sensor arrangement should be completely inside the compressor housing, in order to ensure optimum protection of the relevant system constituents of the sensor arrangement and in addition to enable wiring to be within the housing when no wireless signal transmission paths should be used. It is true that the structural integration of the sensor arrangement in the compressor housing increases the construction complexity of the compressor housing, but this additional effort is compensated by the fact that the ability to integrate the compressor arrangement in complex systems is substantially increased. The extent of the necessary external wiring or signal transmission installation is much reduced, because the communication between the sensor arrangement and the compressor control system is already configured in advance and can be realized internally. The compressor arrangement together with the sensor arrangement forms a monolithic system with a smaller number of mechanical and data interfaces with other system components compared with the prior art, particularly with the fuel cell.

The above-described preferred further development is at the same time a separate aspect of the invention. Thus, as a separate aspect of the invention a compressor arrangement for a fuel cell system, in particular for a vehicle fuel cell system is proposed, with at least one compressor stage which is designed to draw in an air mass-flow, compress it, and deliver it as a reactant supply, a compressor control system designed to control the compressor stage, wherein the compressor arrangement comprises a compressor housing in which the compressor stage is accommodated, and wherein the sensor arrangement is structurally integrated in the compressor housing.

The advantages and preferred embodiments of the compressor arrangement according to the first aspect, described above and in what follows, are at the same time advantages and preferred embodiments of the compressor arrangement according to the second aspect, for which reason, to avoid repetitions, reference should be made to the earlier and subsequent sections.

In a preferred embodiment the compressor housing comprises an inlet duct and an outlet duct, and the mass-flow sensor is integrated in the compressor housing in such manner that it detects the mass-flow in the inlet duct, or in such manner that it detects the mass-flow in the outlet duct. On the assumption that under the operation conditions relevant for fuel cell systems there is no change in the aggregate condition of the through-flowing air, the mass-flow passing through the compressor is constant. For that reason, there is a certain flexibility as to the choice of the measurement point in the compressor arrangement. It has emerged as a simple design to determine the mass-flow within the compressor housing in the inlet or outlet duct, because from there on a simpler design of the wiring with shorter cable paths to the compressor control system is made possible.

The invention relates not only to compressor arrangements with single-stage compressors, but also multi-stage compressor arrangements. Correspondingly, in a preferred embodiment the compressor arrangement comprises a plurality of compressor stages, wherein the outlet of one compressor stage is connected by means of a connecting duct to the inlet of a downstream adjacent compressor stage, and the mass-flow sensor is preferably integrated in the compressor housing in such manner that it detects the mass-flow in the said connecting duct. In preferred embodiments the connecting duct is in the form of a tube or hose duct. This provides great flexibility as regards the choice of measurement point for the sensor arrangement, which potentially enables even shorter signal paths and therefore less internal wiring effort.

In a further preferred embodiment, the reference variable signals include alternatively or in addition a pressure target value signal, and the sensor arrangement comprises a pressure sensor for detecting a pressure as a control variable. Also preferably, the compressor arrangement comprises an expander stage, wherein the compressor stage has an outlet in combination with a cathode-side inlet of a fuel cell of the fuel cell system, and the expander stage has an inlet for connecting to a cathode-side outlet of the fuel cell of the fuel cell system, and the pressure sensor is preferably integrated in the compressor housing in such manner that it detects the pressure at the inlet of the expander stage. When a system as described above is used, which contains a compressor stage and an expander stage in the manner of a turbocharger such as those used in a traditional central motor design, the air compressed by the compressor stage first passes through the fuel cell system, where it gives up its reactants in the stack as part of the fuel cell reaction. The more intensely the release of reactants takes place, the more can the pressure fall at the cathode-side outlet of the fuel cell with an unchanged mass-flow supply. Correspondingly, the pressure at the inlet of the expander stage also falls. If the pressure at the outlet of the fuel cell system or at the inlet of the expander stage is too low, and in particular too close to the ambient pressure, this can be an indicator of a reactant impoverishment in the fuel cell system, which is undesired.

Preferably, the pressure at the inlet of the expander stage is detected as a reference variable and the compressor arrangement is controlled in such manner that the pressure does not fall below a pressure target value predetermined by the fuel cell control system during operation. For this, the compressor control system is preferably connected for signal exchange with the pressure sensor and is designed to generate a control signal as a function of the pressure as a control variable and the pressure target value signal as a reference variable. The said control signal can be for example a control signal for the compressor stage, so as to increase the mass-flow drawn in, compressed, and delivered.

Alternatively, to the use of a pressure sensor integrated in the compressor stage or a pressure sensor arranged between the fuel cell and the compressor arrangement, another preferred embodiment provides that the pressure sensor is integrated in the fuel cell. The pressure sensor is then preferably either connected for signal exchange directly to the compressor arrangement, or it is connected for signal exchange to the fuel cell control system and the fuel cell control system, which for its part is connected for signal exchange to the compressor arrangement, is designed to received the aforesaid pressure signals from the pressure sensor and to pass on representative signals to the compressor arrangement.

In a further preferred embodiment, however, the compressor arrangement comprises a control valve which is designed to adjust the pressure and is functionally connected to the inlet of the expander stage, and the compressor control system is connected for signal exchange with the said control valve and is designed to generate a control signal for the control valve as a function of the pressure as a control variable and of the pressure target value signal as a reference variable. The pressure sensor can be integrated in the control valve, or it can be in the form of a separate pressure sensor. With the control valve, by means of the above-indicated regulation process a dynamic pressure can be produced, which counteracts a potential reactant impoverishment in the fuel cell system.

The control valve does not have to be connected directly to the inlet of the expander stage, but so far as the purpose of the regulation is concerned it can also be arranged outside the compressor arrangement, for example at the outlet of the fuel cell system. However, structural integration in the compressor arrangement facilitates the system integration capability of the compressor arrangement as a whole and with a view to that, the regulation by the control valve can also be taken over by the compressor control system, and the wiring complexity is significantly reduced when the control valve is integrated in the compressor housing and the control valve and the compressor control system are connected for signal exchange by wiring laid inside the housing.

In a further preferred embodiment, the at least one compressor stage comprises an oil-free compressor. The oil-free compressor is preferably one of the following compressor types: radial compressor, axial compressor, roots compressor, scroll compressor. As mentioned earlier the compressor arrangement can also be a multi-stage compressor arrangement. In such a case the compressor arrangement comprises a plurality of compressor stages, each preferably comprising an oil-free compressor, wherein the oil-free compressor is preferably chosen in each case from among the above-mentioned compressor types. Compressors of the same type or of different types can be used.

In a further preferred embodiment, the compressor control system has a first data interface for connecting for the exchanging of signals with a corresponding data interface of the fuel cell control system, and preferably a second data interface for connecting for the exchanging of signals with a corresponding data interface of the sensor arrangement, as well as a processor for processing the control commands and generating the control signals. At least the data interface with the fuel cell control system is preferably in the form of a bus interface such as a CAN bus interface. Owing to the fact that the compressor control system has taken over the control tasks, the bus load in an integrated system is comparatively smaller because the extent of communication between the fuel cell control system and the compressor arrangement by way of the bus can be reduced.

Above, the invention has been described with reference to the compressor arrangement itself. A further aspect the invention relates to a fuel cell system, in particular a vehicle fuel cell system, with a fuel cell which comprises an inlet on the cathode side (for reactants, in particular an air inlet), a fuel cell control system designed to control the fuel cell and monitor it, and a compressor arrangement which is connected fluidically with the cathode-side inlet of the fuel cell and is designed for the admission of compressed air, and a compressor control system connected for the exchange of signals to the fuel cell control system.

With such a fuel cell system too, the invention achieves the task indicated at the beginning, since it is proposed that the compressor arrangement is formed in accordance with one of the embodiments described earlier.

The advantages and preferred embodiments of the compressor arrangement according to the invention are at the same time preferred embodiments and advantages of the fuel cell system according to the invention, for which reason reference should be made to the above descriptions in order to avoid repetitions.

Preferably, the fuel cell control system comprises a processor for controlling the fuel cell and is connected by way of a data interface for the exchange of signals to a corresponding data interface of the compressor control system, preferably a bus interface such as a CAN bus interface.

In a further aspect, the invention relates to a method for controlling a compressor arrangement of a fuel cell system, in particular a vehicle fuel cell system, and the invention relates in particular to a method for controlling a compressor arrangement according to any of the preferred embodiments described above. The method according to the invention has the following steps:
receiving, by a compressor control system of the compressor arrangement, control commands in the form of one or more reference variable signals, preferably containing a mass-flow target value signal and/or a pressure target value signal from a fuel cell control system,
detecting the mass-flow as a control variable by means of a sensor arrangement connected for signal exchange to the compressor control system, and
generating by means of the compressor control system a control signal for the compressor arrangement, as a function of the control variable and the reference variable, for drawing in, compressing, and delivering a compressed air mass-flow.

The advantages and preferred embodiments of the compressor arrangement described earlier and of the fuel cell system described earlier are at the same time advantages and preferred embodiments of the method according to the invention and conversely, so that to avoid repetitions reference should be made to the descriptions given above.

As mentioned earlier, the control of the compressor arrangement can be implemented in a control unit. In this connection, a further aspect of the invention relates to a control unit for a compressor arrangement of a fuel cell system, in particular a vehicle fuel cell system. The invention relates in particular to a control unit for a compressor arrangement according to any of the above-described preferred embodiments. The control unit comprises a first data interface for signal-exchanging connection to a corresponding data interface of a fuel cell control system, a second interface for signal-exchanging connection to a corresponding data interface of a sensor arrangement of the compressor arrangement, a data memory in which a computer program for carrying out the method according to any of the above-described embodiments, and a processor designed to carry out one, more than one, or all of the process steps of the computer program.

Again, the advantages and preferred embodiments of the above-described compressor arrangement, the above-described fuel cell system, and the above-described method are at the same time advantages and preferred embodiments of the control unit and conversely, so that again, to avoid repetitions, reference should be made to the explanations given earlier.

### BRIEF DESCRIPTION OF THE DRAWINGS

Below, the invention is described in greater detail with reference to the attached figures and to preferred example embodiments. The figures show:

FIG. 1: A schematic representation of a fuel cell system according to a first preferred example embodiment,

FIG. 2: A schematic representation of a fuel cell system according to a second preferred example embodiment,

FIG. 3: A schematic representation of a control method for the fuel cell systems in the two example embodiments, and

FIG. 4: A schematic representation of a control unit for the method according to FIG. 3.

### DETAILED DESCRIPTION

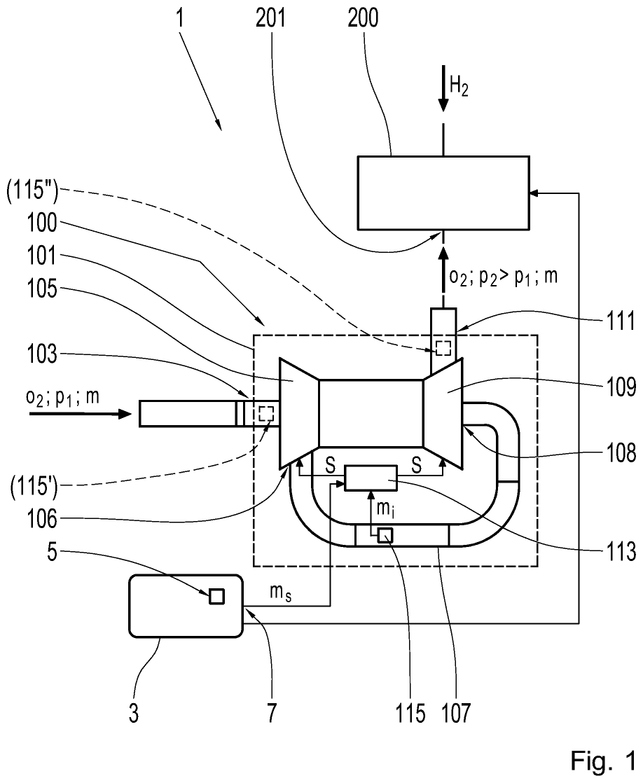

FIG. 1 shows a fuel cell system 1, in particular a vehicle fuel cell system. The fuel cell system 1 comprises a compressor arrangement 100 and a fuel cell 200. The fuel cell 200 is controlled by a fuel cell control system 3 which is connected for signal exchange with the fuel cell 200.

Hydrogen is supplied to the anode side of the fuel cell 200 and a material mix containing oxygen, for example air, to its cathode side. For the supply of the material mix containing oxygen, the fuel cell 200 has an inlet 201.

To be able to supply a sufficient quantity of the oxygen-containing mix, the fuel cell system 1 comprises the compressor arrangement 100. The compressor arrangement 100 comprises a compressor housing 101. On the compressor housing 101 is formed a suction duct 103 through which air from a first compressor stage 105 can be drawn in. The first compressor stage 105 is for example in the form of a radial compressor. An outlet 106 of the first compressor stage 105 is fluidically connected by way of a connecting duct 107, for example in the form of a connecting tube, to an inlet 108 of a second compressor stage 109. The second compressor stage 109 is preferably also in the form of a radial compressor. The first compressor stage 105 and the second compressor stage 109 successively compress the oxygen-containing material mix, for example air (referred to simply as air in what follows), and deliver a compressed air mass-flow at a pressure p₂ via an outlet duct 111 in the direction toward the fuel cell 200, the pressure p₂ being higher owing to the compression than an inlet pressure p₁ at the suction duct 103. When the compressor arrangement 100 is operating under constant conditions, the mass-flow m is also constant.

The demand for oxygen on the cathode side of the fuel cell 200 can vary as a function of the other reaction parameters. Monitoring of the reaction parameters is carried out by the fuel cell control system 3, which comprises a processor 5 designed for the purpose. In situations in which the fuel cell control system 3 deems it necessary to adapt the quantity of oxygen supplied to the fuel cell 200, by way of a data interface 7 it sends a reference variable signal to the compressor arrangement 100. The compressor arrangement 100 has a compressor control system 113 which is designed to control the compressor stages 105 and 109 and if necessary to control other components as well (which, for the sake of greater clarity, are not shown here).

The compressor control system 113 is connected for signal exchange to the data interface 7 of the fuel cell control system 3 and is designed to receive reference variable signals from fuel cell control system 3.

The compressor arrangement 100 comprises a mass-flow sensor 115 structurally integrated in the compressor housing 101, which sensor is connected for signal exchange with the compressor control system 113. By virtue of the structural integration, it is possible to accommodate the signal connection inside the housing. Since the compressor control system 113 is connected for signal exchange both to the fuel cell control system 3 and to the mass-flow sensor 115, the compressor control system 113 can carry out the regulation of the mass-flow supplied by the compressor arrangement 100 and to that extent, relieve the fuel cell control system 3 of that task. Thus, it is sufficient for the reference variable signal from the fuel cell control system 3 to contain a mass-flow target value signal mₛ, which is used as a reference variable by the compressor control system 113 in order, by feeding back the actual value mᵢ of the mass-flow supplied by the mass-flow sensor 115, to control the various components of the compressor arrangement 100 and to generate the control signals S necessary for that. As an example, it is shown in FIG. 1 that the compressor control system 113 sends control signals to the compressor stages 105 and 109. Alternatively, or in addition, however, it is also possible that the compressor control system 113 controls further components of the compressor arrangement 100 such as throttle valves and the like.

The mass-flow sensor 115 is arranged, for example, in the connecting duct 107 between the compressor stages 105 and 109. Alternatively, however, the mass-flow sensor 115 can be arranged in the compressor housing 101 in the area of the suction duct 103 (indicated by an index 115′) or in the outlet duct 111 (indicated by an index 115″).

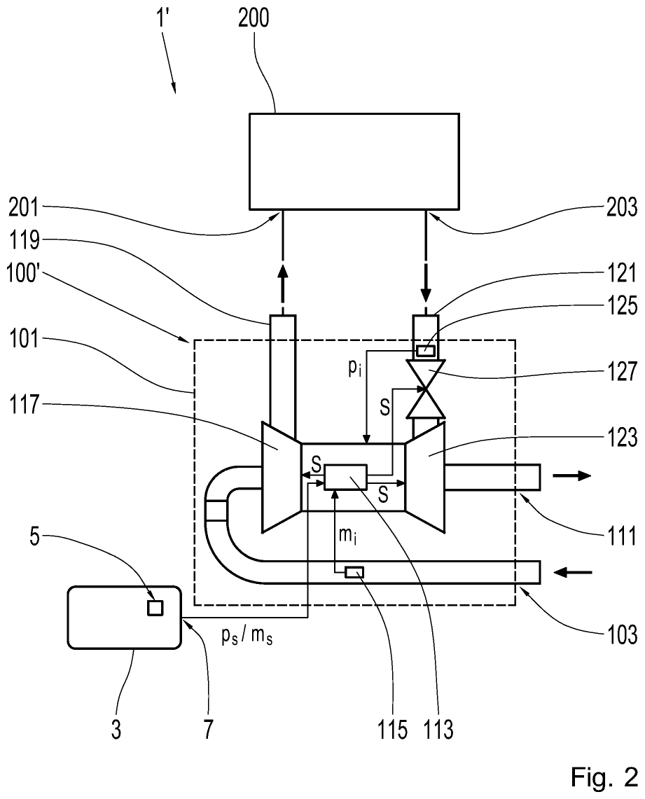

The example embodiment according to FIG. 2 shows a fuel cell system 1′ with a fuel cell 200 and a compressor arrangement 100′. In many respects the compressor arrangement 100′ is the same as the compressor arrangement 100 in FIG. 1, for which reason identical indexes are used for identical functional elements. To that extent, to avoid repetitions reference can be made to the description of FIG. 1.

Other than in the compressor arrangement 100 of FIG. 1, the compressor arrangement 100′ does not comprise two compressor stages but only one compressor stage 117, which compresses the air drawn in and delivers it via an outlet 119 to the inlet 201 of the fuel cell 200. After passing though the stack (not shown) inside the fuel cell 200, that air is returned again via an outlet 203 on the fuel cell side to the compressor arrangement 100′, which it enters again via an inlet 121. The inlet 121 opens into an expander stage 123 in which the air mass-flow expands and is then discharged via the outlet 111 of the compressor arrangement 100′.

The example embodiment according to FIG. 2 can have the same mass-flow regulation system as in FIG. 1. This is not shown in FIG. 2, because another regulation aspect should be mentioned here: the compressor arrangement 100′ comprises a pressure sensor 125 structurally integrated in the area of the inlet 121 in the compressor housing 101. The pressure sensor 125 is connected for signal exchange with the compressor control system 113. The compressor arrangement 100′ also comprises a control valve 127 upstream from the expander stage 123, which is also connected for signal exchange with the compressor control system 113.

The fuel cell control system 3, which is also connected for signal exchange with the compressor control system 113, is designed to send a reference variable signal to the compressor control system 113, which signal contains a pressure target value signal pₛ. The compressor control system 113 is designed, as a function of the pressure target value signal pₛ received as a reference variable and of the pressure signal pᵢ from the pressure sensor 125, to regulate the pressure at the control valve 127 by generating corresponding control signals in such manner that the pressure target value predetermined by the fuel cell control system 3 is maintained, in particular that the pressure does not fall below that value. In that way the fuel cell 200 is protected against reactant impoverishment on the cathode side.

The regulation tasks described in the example embodiments according to FIG. 1 and FIG. 2 can be carried out by the same compressor control system 113, and the same data interfaces can be used for communicating the corresponding reference variable signals.

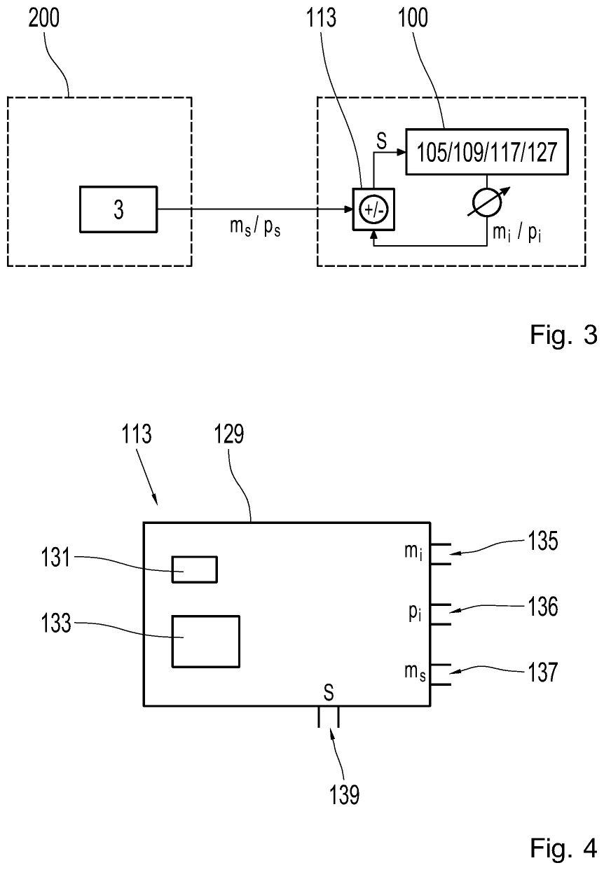

FIG. 3 shows a schematic representation of the regulation process that takes place in both of the example embodiments, for controlling the compressor arrangement. During the operation of the compressor arrangement 100 air is drawn in, compressed, and delivered as a compressed air mass-flow from the compressor arrangement 100 is the direction toward the fuel cell 200. An actual control variable (mass-flow mᵢ/pressure pᵢ) is provided as the control variable of the compressor control system 113.

When the compressor control system 113 receives from the fuel cell control system 3 a reference variable signal (mass-flow target value signal mₛ/pressure target value signal pₛ), the compressor control system 113 determines the existing control deviation and, to eliminate the control deviation, produces a control signal S by virtue of which the control variable is caused to approach the reference variable. The correcting elements actuated can for example be parts of the compressor stages 105, 109, 117, or the control valve 127. If necessary other elements can also be actuated, which for the sake of greater clarity are not shown explicitly.

For both example embodiments, a relevant aspect of the method is that the control loop runs completely inside the compressor arrangement 100 and there, in the compressor control system 113. There is no feedback communication between the fuel cell 200 or the fuel cell control system 3 and the compressor control system 113. Only a reference variable signal is sent from the fuel cell control system 3 to the compressor control system 113, which therefore simplifies the communication between the two system components. It can be provided that after the successful elimination of the control deviation, the compressor control system 113 emits a confirmation signal to the fuel cell control system 3, so to speak, as an acknowledgement.

FIG. 4 shows a design for the compressor control system 113. The compressor control system 113 is preferably implemented in a control unit 129. The control unit 129 comprises a processor 131 which is designed to carry out the commands and control and regulation tasks The control unit 129 also comprises a data memory 133 in which is stored a computer program with a method according to the above-described preferred embodiments, particularly in accordance with FIG. 3, such that the said processor 131 is designed to read out and implement the method stored in the data memory 133.

The control unit 129 also comprises a first data interface 135 for signal-exchanging connection to the mass-flow sensor 115. Furthermore, the control unit 129 comprises a second data interface 136 for signal-exchanging connection to the pressure sensor 125.

In addition, the control unit 129 comprises a third data interface 137 for signal-exchanging connection to the fuel cell control system 3.

Furthermore, the control unit 129 comprises one or more fourth data interfaces 139 (only one is shown) for signal-exchanging connection to the component or components of the compressor arrangement 100, 100′ to be controlled, for example the compressor stages 105, 109, 117 and/or the control valve 127.

### INDEXES (PART OF THE DESCRIPTION)

1, 1′ Fuel cell system
3 Fuel cell control system
5 Processor of the fuel cell control system
7 Data interface
100, 100′ Compressor arrangement
101 Compressor housing
103 Suction duct
105 First compressor stage
106 Outlet of the first compressor stage
107 Connecting duct
108 Inlet of the second compressor stage
109 Second compressor stage
111 Outlet duct
113 Compressor control system
115 Mass-flow sensor
117 Compressor stage
119 Outlet of the compressor stage
121 Inlet of the expander stage
123 Expander stage
125 Pressure sensor
127 Control valve
129 Control unit
131 Processor
133 Data memory
135 First data interface
136 Second data interface
137 Third data interface
139 Fourth data interface
200 Fuel cell
201 Inlet of the fuel cell
203 Outlet of the fuel cell
m Mass-flow
mᵢ Actual value of the mass-flow
mₛ Mass-flow target value signal
p₁ Inlet pressure
p₂ Pressure
pᵢ Pressure signal
pₛ Pressure target value signal
S Control signal

1. A compressor arrangement (100, 100′) for a fuel cell system (1, 1′), the arrangement comprising:
at least one compressor stage (105, 109, 117) configured to draw in a mass-flow (m) of air, compress it and deliver a compressed air mass-flow (m) as a reactant supply; and
a control system (113) configured to control the at least one compressor stage (105, 109, 117) and further configured to be connected for signal exchange to a fuel cell control system (3) and to receive control commands from the fuel cell control system (3);
wherein the control commands include a target value signal (mₛ, pₛ) as a reference variable that represents a required reactant supply, the compressor arrangement (100, 100′) comprises a sensor arrangement configured and arranged for detecting a control variable, and the compressor arrangement control system (113) is connected for signal exchange with the sensor arrangement and is designed, as a function of the control variable and the reference variable, to generate a control signal (S) for the compressor stage (105, 109, 117).

2. The compressor arrangement (100, 100′) according to claim 1, wherein the target value signal that represents the required reactant supply is a mass-flow target value signal (mₛ) and the sensor arrangement comprises a mass-flow sensor (115) for detecting the air mass-flow as a control variable (mᵢ).

3. The compressor arrangement (100, 100′) according to claim 1, comprising a compressor housing (101) in which the compressor stage (105, 109, 117) is accommodated, wherein the sensor arrangement is structurally integrated in the compressor housing (101).

4. The compressor arrangement (100, 100′) according to claim 3, wherein the compressor housing (101) has a suction duct (103) and an outlet duct (111), and the mass-flow sensor (115) is integrated in the compressor housing (101) in such manner that it is configured to detect the mass-flow (m) in the suction duct (103), or in such manner that it is configured to detect the mass-flow (m) in the outlet duct (111).

5. The compressor arrangement (100) according to claim 2, wherein the compressor arrangement (100) comprises a plurality of compressor stages (105, 109), wherein the outlet (106) of one compressor stage (105, 109, 117) is connected by means of a connecting duct (107) to the inlet (108) of a downstream adjacent compressor stage (105, 109, 117), and the mass-flow sensor (115) is preferably integrated in the compressor housing (101) in such manner that it detects the mass-flow (m) in the connecting duct (107).

6. The compressor arrangement (100′) according to claim 1, wherein the reference variable signals contain a pressure target value signal (pₛ), and the sensor arrangement comprises a pressure sensor (125) for detecting a pressure as a control variable (pᵢ).

7. The compressor arrangement (100′) according to claim 6, wherein the compressor arrangement (100′) comprises an expander stage (123), wherein the compressor stage (117) has an outlet (119) for connection to a cathode-side inlet (201) of a fuel cell (200) of the fuel cell system (1, 1′), and the expander stage (123) has an inlet (121) for connection to a cathode-side outlet (203) of the fuel cell (200) of the fuel cell system (1, 1′), and the pressure sensor (125) is preferably integrated in the compressor housing (101) in such manner that it detects the pressure (pᵢ) at the inlet (121) of the expander stage (123).

8. The compressor arrangement (100, 100′) according to claim 6, wherein the compressor control system (113) is connected for signal exchange with the pressure sensor (125) and is designed to generate a control signal (S) as a function of the pressure as a control variable (pᵢ) and of the pressure target value signal as a reference variable (pₛ).

9. The compressor arrangement (100′) according to claim 6, wherein the compressor arrangement (100′) comprises a control valve (127) configured and arranged to adjust the pressure, the control valve being functionally connected to the inlet (121) of the expander stage (123), and the compressor control system (113) is connected for signal exchange with the control valve (127) and configured to generate a control signal (S) for the control valve (127) as a function of the pressure as a control variable (pᵢ) and the pressure target value signal (pₛ) as the reference variable.

10. The compressor arrangement (100, 100′) according to claim 3, wherein the compressor control system (113) is integrated in the compressor housing (101), and the sensor arrangement and the compressor control system (113) are connected for signal exchange by wiring laid within the housing (101).

11. The compressor arrangement (100, 100′) according to claim 10, wherein the control valve (127) is integrated in the housing (101) and the control valve (127) and the compressor control system (113) are connected for signal exchange by wiring laid within the housing (101).

12. The compressor arrangement (100, 100′) according to claim 1, wherein the at least one compressor stage (105, 109, 117) comprises an oil-free compressor selected from one of the following compressor types:
radial compressor,
axial compressor,
roots compressor,
scroll compressor.

13. The compressor arrangement (100, 100′) according to claim 1, wherein the compressor control system (113) comprises a first data interface (135) for signal-exchanging connection to a corresponding data interface of the fuel cell control system (3), and a second data interface for signal-exchanging connection to a corresponding data interface of the sensor arrangement, the first and second data interface each being in the form of a BUS interface, and a processor (131) for processing the control commands and for generating the control signal (S).

14. A fuel cell system (1, 1′), comprising:
a fuel cell (200) with an inlet (201) on a cathode side,
a fuel cell control system (3) configured to control and monitor the fuel cell (200), and
a compressor arrangement (100, 100′) fluidically connected to the inlet on the cathode-side of the fuel cell (200) and which comprises a compressor control system (113) connected for signal exchange with fuel cell control system (3), wherein the compressor arrangement (100, 100′) is configured according to claim 1.

15. A fuel cell system (1, 1′) according to claim 14, wherein the fuel cell control system (3) comprises a processor for controlling the fuel cell (200), and is connected for signal exchange by way of a BUS data interface to a corresponding data interface (135) of the compressor control system (113).

16. A method for controlling a compressor arrangement (100, 100′) of a compressor arrangement (100, 100′) according to claim 1, comprising the following steps:
receiving, by a compressor control system (113) of the compressor arrangement (100, 100′), of control commands in the form of one or more reference variable signals, preferably including a mass-flow target value signal (mₛ) and/or a pressure target value signal (pₛ), from a fuel cell control system (3);
detecting the air mass-flow (m) as a control variable by means of a sensor arrangement connected for signal exchange with the compressor control system (113); and
by means of the compressor control system (113), generating a control signal (S) for the compressor arrangement (100, 100′), as a function of the control variable and the reference variable, for drawing in, compressing and delivering a compressed air mass-flow (m).

17. A control unit for a compressor arrangement (100, 100′) of a vehicle fuel cell system the compressor arrangement (100, 100′) according to claim 1, the control unit comprising:
a first data interface (135) configured for signal-exchanging connection to a corresponding data interface (7) of a fuel cell control system (3);
a second data interface (136) configured for signal-exchanging connection to a corresponding data interface (7) of a sensor arrangement of the compressor arrangement (100, 100′);
a data memory (133) comprising a computer program for carrying out the method according to claim 16; and
a processor (131) one or more of the process steps of the computer program.

18. The compressor arrangement (100, 100′) according to claim 1, wherein the at least one compressor stage (105, 109, 117) comprises a plurality of compressor stages, each compressor of the plurality of compressor stages comprising an oil-free compressor selected from a radial compressor, an axial compressor, a roots compressor, and a scroll compressor.
